(19) United States
(12) Patent Application Publication
(10) Pub. No.: US 2026/0067670 A1
(43) Pub. Date: Mar. 5, 2026

(54) NETWORK NODES AND METHODS IN A COMMUNICATIONS NETWORK

(71) Applicant: Telefonaktiebolaget LM Ericsson (publ), Stockholm (SE)

(72) Inventors: Miguel Angel MUÑOZ DE LA TORRE ALONSO, Madrid (ES); Carlota VILLASANTE MARCOS, Madrid (ES); Victor GOMEZ-HIDALGO PEREZ, Torrijos (ES)

(21) Appl. No.: 19/105,132

(22) PCT Filed: Apr. 6, 2023
(86) PCT No.: PCT/EP2023/059113

§ 371 Date: Feb. 20, 2025

(30) Foreign Application Priority Data
Aug. 22, 2022 (EP) 22382794.0

(51) Int. Cl. H04W 8/22; H04L 41/0894; H04W 48/18; H04W 60/04

(52) U.S. Cl. CPC H04W 8/22; H04L 41/0894; H04W 48/18; H04W 60/04

(57) ABSTRACT

Embodiments herein relate to a method performed by a network node for handling communication related to a UE in a communications network. The network node transmits a message to another network node, wherein the message is related to a proxy capability such as requesting or indicating a TURN and/or STUN capability in a communication.

### TECHNICAL FIELD

Embodiments herein relate to network nodes and methods therein. Furthermore, a computer program and a computer readable storage medium are also provided herein. Embodiments relate to handling communication in a communications network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3rd Generation Partnership Project (3GPP) is the standardization body for specify the standards for the cellular system evolution, e.g., including 3G, 4G, 5G and the future evolutions. Specifications for the Evolved Packet System (EPS), also called a Fourth Generation (4G) network, have been completed within the 3GPP. As a continued network evolution, the new releases of 3GPP specifies a 5G network also referred to as 5G New Radio (NR). Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

FIG. 1 depicts the 5G reference architecture as defined by 3GPP. The network functions (NF) shown in FIG. 1 are described below.

The Application Function (AF) or application server (AS) interacts with the 3GPP Core Network and allows external parties to use the Exposure application programming interfaces (API) offered by the network operator. The AF provides session related information to other nodes in the 5G core network (5GC).

The Network Exposure Function (NEF) supports different functionalities and NEF supports different Exposure APIs.

Network Repository Function (NRF) works as a registration centre of network functions (NF).

The Unified Data Repository (UDR) stores data grouped into distinct collections of subscription-related information: Subscription Data; Policy Data; Structured Data for Exposure; Application Data.

The Session Management function (SMF) supports different functionalities, e.g. SMF receives PCC rules from the Policy Control Function (PCF) and configures the User Plane function (UPF) accordingly.

The User Plane function (UPF) supports handling of user plane traffic based on the rules received from the SMF, e.g., packet inspection and different enforcement actions such as QoS handling.

The Policy Control Function (PCF) supports a unified policy framework to govern the network behaviour. Specifically, the PCF provides Policy and Charging Control (PCC) rules to the Policy and Charging Enforcement Function (PCEF), i.e., the SMF/UPF that enforces policy and charging decisions according to provisioned PCC rules.

The Access and Mobility Management Function (AMF) manages UE access, e.g., when a UE is connected through different access networks, and UE mobility aspects.

A Session Traversal Utilities for Network Address Translation (STUN) protocol is an integral component of the Audio/Video Media Relay service. It provides routing information and signalling that is needed to establish a secure media connection for all endpoints that are involved in audio/video communications.

Traversal Using Relays around Network Address Translation (TURN) is a protocol that assists in the traversal of network address translation (NAT) or firewalls for Web Real-Time Communication (webRTC) applications. TURN Server allows clients to send and receive data through an intermediary server.

Currently, Content Providers deploy their own STUN and TURN servers, even inside Mobile Network Operator's (MNO) network.

### Proxy

Conceptionally, a proxy is an intermediary program acting as both server and client, creating or simply relaying requests on behalf of other entities. Requests are serviced internally or by passing them on, with possible translation, to other servers. There are several types of proxies, where we focus on the following:
A “transparent proxy” is a proxy that does not modify the request or response beyond what is required for proxy authentication and identification.
A “non-transparent proxy” is a proxy that modifies the request or response to provide some added service to the user agent, such as group annotation services, media type transformation, protocol reduction, or anonymity filtering.
A “reverse proxy” is basically a proxy that pretends to be the actual server, as far as any client or client proxy is concerned, but it passes on the request to the actual server that is usually sitting behind another layer of firewalls.
A “Performance Enhancement Proxy (PEP)” is used to improve the performance of protocols on network paths where native performance suffers due to characteristics of a link or subnetwork on the path.

### SUMMARY

As part of developing embodiments herein one or more problems were first identified and will first be discussed.

The following problems were identified:

A connection created between end parties for voice over IP (VoIP) applications, e.g., Skype, Teams, can either be:
A direct peer to peer (P2P) connection between the peers, e.g., A calls B.
Through a proxy.
   The reason why the connection through a proxy is required, and a direct P2P connection is not possible, is NAT deployment:
When the NAT translation only depends on origin parameters, such as source IP and source port, which is the case for Full Cone NAT, the translation might be discovered, e.g., through STUN, by the other peer so the direct P2P connection can be established.
When the NAT translation also depends on destination parameters, e.g., Symmetric NAT, it is not possible to use STUN, so the direct P2P connection cannot be established. This also applies to the restricted cone NAT, because the peers can't reach each other as they don't have a previously established communication and they can't start a new one due to the restrictions.

Symmetric NAT is optimal against the other NAT types for public IP address reuse, as with a single public IP address it is possible to have a lot more connections, but it has the disadvantage of not allowing direct P2P connections. This forces each Content Provider to deploy a TURN server.

Problem with STUN: it does not work with all types of NAT.

Regarding TURN:
It is not a P2P communication, since the server is a relay.
Can be a bottleneck, for example, when lots of VoIP at the same time, that are centralized in the TURN server.
Opportunity cost against P2P communications since one more element is needed.

An object of embodiments herein is to improve the performance of a communications network by a more efficient handling of communication in a communications network.

According to an aspect of embodiments herein, the object is achieved by a method performed by a network node for handling communication related to a UE in a communications network. The network node transmits a message to another network node, wherein the message is related to a proxy capability, such as requesting or indicating a TURN and/or STUN capability, in a communication such as a direct communication, an end-end communication or similar. The network node may be a core network node such as a network function node, and the message may be a request with an indication of a proxy configuration such as a TURN and/or STUN configuration.

For example, a UPF transmits a registration message to a NRF, wherein the registration message comprises a proxy capability such as a TURN and/or STUN capability.

Another example, an Application server (AS) transmits a request towards MNO, to a NEF, to deploy/assign/select TURN and/or STUN server/s inside a communications network of the MNO. The request comprises a Requested Proxy configuration: identifies the requested Proxy configuration, e.g. to indicate allocation of a TURN server and/or a STUN server and the corresponding configuration.

The network node may be a UDR that transmits, to a PCF, a subscriber policy data that includes a policy for allocating TURN and/or STUN server with specific configuration for an application identity (App-ID).

The network node may be a management node such as an SMF that selects a UPF supporting a requested TURN & STUN capability and triggers Session Establishment procedure towards the selected UPF including the following parameters: App-ID and Requested TURN and/or STUN configuration.

According to another aspect of embodiments herein, the object is achieved by a method performed by another network node, a second network node, for handling communication related to a UE in a communications network. The second network node receives a message from a first network node, wherein the message is related to a proxy capability such as requesting or indicating a TURN and/or STUN capability. The second network node may be a core network node such as a network function node, and the message may be a request with an indication of a proxy configuration such as a TURN and/or STUN configuration for a communication such as a direct communication, an end-end communication or similar.

The second network node may be an NRF that receives a registration message from a UPF, wherein the registration message comprises a proxy capability such as a TURN and/or STUN capability. The NRF stores an indication of proxy capability and may answer UPF with a confirmation message indicating successful operation.

The second network node may be an NEF that receives a request to deploy/assign/select TURN and/or STUN server/s inside a communications network of the MNO. The request comprises a Requested Proxy configuration: identifies the requested Proxy configuration, e.g. to indicate allocation of a TURN server and/or a STUN server and the corresponding configuration. The NEF authorizes the request, and answers an AS with a confirmation message indicating successful operation and stores it in UDR.

The second network node may be a policy node such as a PCF that retrieves from the UDR, a subscriber policy data that includes a policy for allocating TURN and/or STUN server with specific configuration for the App-ID. The policy node generates PCC rules including a PCC rule for the App-ID including the requested TURN & STUN configuration.

The second network node may be a UPF that detects traffic for an App-ID and applies actions requested in a forwarding action rule (FAR) comprising requested TURN and/or STUN configuration. The UPF further sends traffic according to requested TURN and/or STUN configuration.

The second network node may be a TURN and/or STUN node that receives traffic and applies requested TURN and/or STUN configuration.

According to yet another aspect of embodiments herein, the object is achieved by providing a network node and a second network node configured to perform the embodiments herein.

Thus, it is herein provided a network node for handling communication related to a UE in a communications network, wherein the network node is configured to transmit a message to another network node, wherein the message is related to a proxy capability in a communication.

In addition, it is herein provided a second network node for handling communication related to a UE in a communications network, wherein the second network node is configured to receive a message from a first network node, wherein the message is related to a proxy capability in a communication.

It is furthermore provided herein a computer program product comprising instructions, which, when executed on at least one processor, cause the at least one processor to carry out the methods herein, as performed by the network node and the second network node, respectively. It is additionally provided herein a computer-readable storage medium, having stored thereon a computer program product comprising instructions which, when executed on at least one processor, cause the at least one processor to carry out the methods herein, as performed by the network node and the second network node, respectively.

Embodiments herein bring the advantage of an efficient mechanism improving the handling of NAT. This is achieved by providing a mechanism which solves one or more of the above problems and provides a message related to a proxy capability, e.g., requesting or indicating a TURN and/or STUN capability. Some embodiments herein are based on API Exposure, through NEF, for Content Provider to request MNO to deploy/assign/select a Proxy, TURN and/or STUN server/s, owned by MNO, e.g. at edge and/or UPF, i.e., MNO has a Proxy (TURN and STUN servers) deployed and the Content Provider requests to use the Proxy. Additionally, the Content Provider may request through an extensible API to extend the functionality of the TURN/STUN server with own proprietary new features, only for the Content Provider requesting it.

The proposed solution allows one or two servers, one STUN server and/or one TURN server, to permit either a P2P communication, when STUN is possible, or a communication through a proxy, when TURN needed, but with the proxy located in the same path of the P2P communication, the communication does not need to go to the Content Provider's network.

The claimed solution has one or more of the following advantages:
As the TURN and/or STUN server is located between the peers at MNO's network, e.g., edge UPF, it is in the faster path.
There is no bottleneck due to decentralization in each MNO's network, the proxy could be even deployed in the edge.
Although the proxy is an extra element, it is proposed to use STUN and to interact with the Carrier-grade NAT (CGNAT) module, as everything happens inside the MNO's network.
Reduce total cost of ownership (TCO) in the Content Provider side because they can reuse the proxy, such as STUN and TURN servers, developed by the MNO. The Content Provider does not need to develop, deploy and maintain any STUN or TURN server.
New source of revenue for the MNOs as they can monetize this new service.

### BRIEF DESCRIPTION OF THE DRAWINGS

Examples of embodiments herein are described in more detail with reference to attached drawings in which:

FIG. 1 is a schematic block diagram illustrating an architecture according to prior art.

FIG. 2a is a schematic overview illustrating embodiments of a communications network.

FIG. 2b is a schematic flowchart illustrating embodiments herein.

FIG. 2c is a schematic flowchart illustrating embodiments herein.

FIG. 3a is a combined flowchart and signalling scheme illustrating embodiments herein.

FIG. 3b is a combined flowchart and signalling scheme illustrating embodiments herein.

FIG. 3c is a combined flowchart and signalling scheme illustrating embodiments herein.

FIG. 4a is a signaling diagram depicting examples of embodiments herein.

FIG. 4b is a signaling diagram depicting examples of embodiments herein.

FIGS. 5a and 5b are schematic block diagrams illustrating embodiments of a network node.

FIGS. 6a and 6b are schematic block diagrams illustrating embodiments of a network node.

FIG. 7 schematically illustrates a telecommunication network connected via an intermediate network to a host computer.

FIG. 8 is a generalized block diagram of a host computer communicating via a base station with a user equipment over a partially wireless connection.

FIGS. 9, 10, 11 and 12 are flowcharts illustrating methods implemented in a communication system including a host computer, a base station and a user equipment.

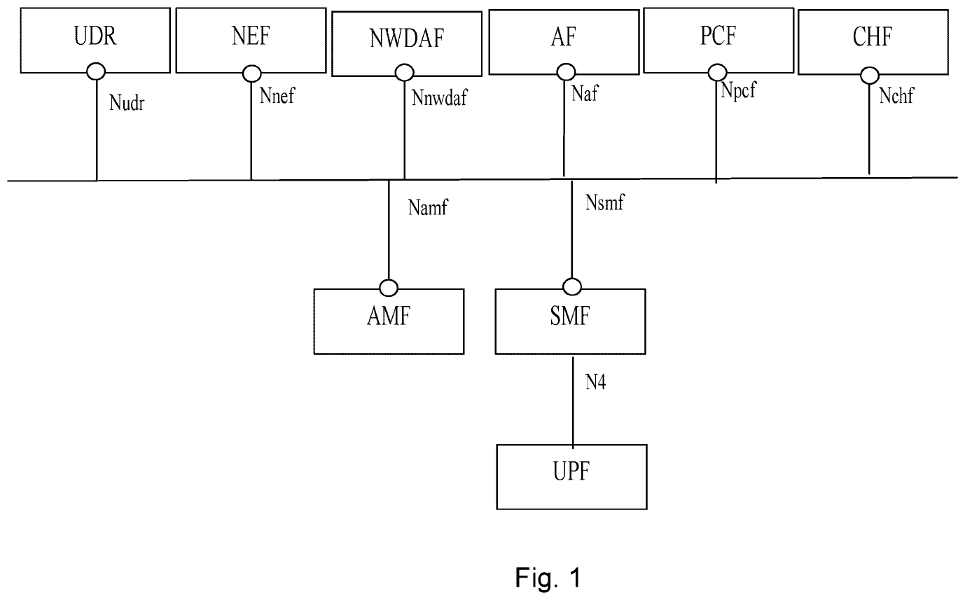

### DETAILED DESCRIPTION

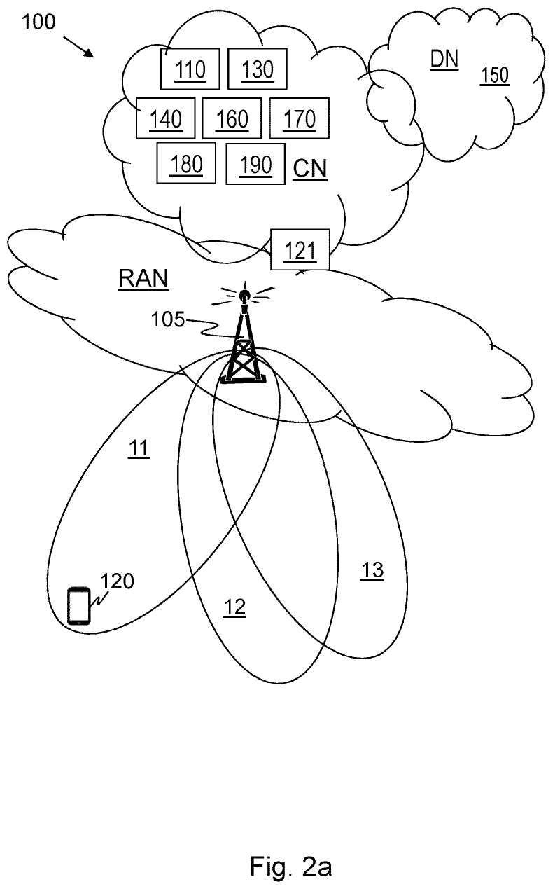

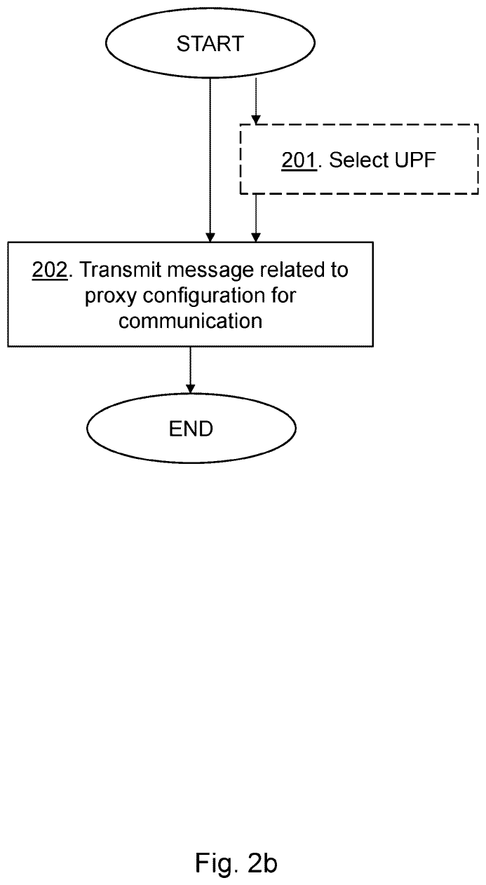

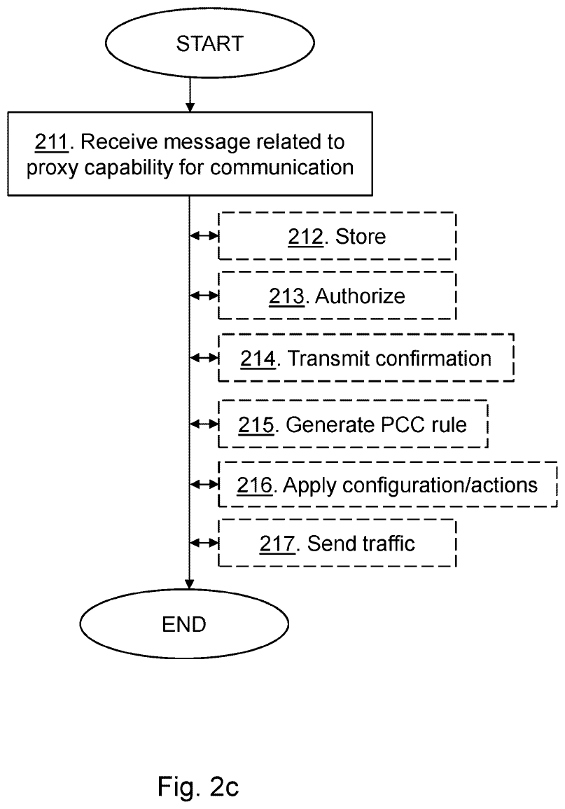

FIG. 2a is a schematic overview depicting a communications network 100 wherein embodiments herein may be implemented. The communications network 100 comprises one or more RANs and one or more CNs. The communications network 100 may use 5G NR but may further use a number of other different technologies, such as, 6G, Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

One or more UEs such as e.g. UE 120, operate in the communications network 100. The UE 120 may e.g. be 5G-residential gateway (RG), a remote UE, a wireless device, an NR device, a mobile station, a wireless terminal, an internet of things (IoT) capable device, an machine type communications (MTC) device, an eMTC device, a CAT-M device, a WiFi device, an LTE device and an a non-access point (non-AP) STA, a STA, that communicates via a base station such as e.g. a base station 105, one or more Access Networks (AN), e.g. a RAN, to one or more core network (CN) nodes such as e.g. a policy node 110, in one or more CNs. The UE 120 may communicate with one or more CN nodes, such as the policy node 110, by a fixed network connection, such as e.g. cable and/or optical fiber. It should be understood by the skilled in the art that “UE” is a non-limiting term which means any terminal, wireless communication terminal, user equipment, Device to Device (D2D) terminal, or node e.g. smart phone, laptop, mobile phone, sensor, relay, mobile tablets or even a car or any small base station communicating within a first cell 11 provided by base station 105. The UE 120 may communicate with other nodes in the communications network 100.

A proxy or a proxy server 121 may operate in the communications network 100. E.g. the proxy server 121 may operate in a radio device, such as e.g. the UE 120. According to example of embodiments herein the proxy server may be a TURN server and/or a STUN server.

Base stations such as the base station 105 or radio network node, operate in the communications network 100. The base station 105 provides a first cell 11, and possibly a neighbor second cell 12 and third cell 13. The base station may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point or an Access Point Station (AP STA), an access controller, or any other network unit capable of communicating with UEs such as the UE 120, within a first cell 11, served by the base station 105 may be referred to as a serving radio network node and communicates with the UE 120 with Downlink (DL) transmissions to the UE 120 and Uplink (UL) transmissions from the UE 120. The second cell 12 and third cell 13, among neighbor cells to the first cell 11, may be served by a second network node, not shown in FIG. 2a, capable of communicating with UEs. The first cell 11 and the second cell 12 may belong to the same tracking area and the third cell 13 may belong to different tracking area.

One or more of the following network nodes may operate in the CN of the communications network 100. A network node may be referred to as a core network node, a NF node or similar.

A user plane node 170, such as, e.g., a User Plane Function (UPF) node. The user plane node 170 supports handling of user plane traffic. The user plane node 170 performs packet inspection and different enforcement actions, e.g., traffic steering, Quality of Service and/or Charging/Reporting.

A policy node 110, such as, e.g., a Policy Control Function (PCF) node. The policy node 110 supports a unified policy framework to govern network behaviour. The policy node 110 provides policies and rules to, e.g., the UE 120 and/or the user plane node 170, that enforces policy and charging decisions, e.g., according to provisioned rules.

A session management node 140, such as e.g. a Session Management Function (SMF) node. The session management node 140 supports different functionality, such as e.g. session establishment, modify and release, and policy related functionalities.

A NEF node 130. The NEF 130 supports different functionalities and NEF supports different Exposure APIs.

A subscriber data node 160, such as e.g. a Unified Data Repository (UDR) node. The subscriber data node 160 supports different functionality, such as e.g. acting as a repository of subscriber information and may be used to service a number of different network functions.

An Application Server (AS) 180 interacts with the 3GPP Core Network and allows external parties to use the Exposure application programming interfaces (API) offered by the network operator. The AS provides session related information to other nodes in the 5GC.

A Network Repository Function (NRF) 190 works as a registration centre of network functions (NF).

Methods according to embodiments herein are performed by the network nodes. These nodes may be Distributed Nodes (DN)s and functionality, e.g. comprised in a cloud 150 as shown in FIG. 2a may be used for performing or partly performing the methods.

FIG. 2b shows a flowchart describing a method performed by a network node 500, such as the UPF, UDM, AS, or SMF, for handling communication related to a UE in a communications network. Optional actions are marked with dashed boxes.

Action 201. The network node 500 may select a UPF supporting a requested TURN &/or STUN capability.

Action 202. The network node 500 transmits a message to another network node, wherein the message is related to a proxy capability such as a TURN and/or STUN capability in a communication such as a direct communication, an end-end communication or similar. The network node 500 may be a core network node such as a network function node, and the message may be a request with an indication of a proxy configuration such as a TURN and/or STUN configuration, a TURN and/or STUN capability or a NAT related capability/configuration.

For example, the network node 500 may be a UPF that transmits, action 202, a registration message to a NRF, wherein the registration message comprises a proxy capability such as a TURN and/or STUN capability.

Another example, the network node 500 may be an Application server (AS) that transmits a request, action 202, towards MNO, to a NEF, to deploy/assign/select TURN and/or STUN server/s inside a communications network of the MNO. The request comprises a Requested Proxy configuration: identifies the requested Proxy configuration, e.g. to indicate allocation of a TURN server and/or a STUN server and the corresponding configuration.

The network node 500 may be a UDR that transmits, action 201, to a PCF, a subscriber policy data that includes a policy for allocating TURN and/or STUN server with specific configuration for an application identity (App-ID).

The network node 500 may be a management node such as an SMF that selects a UPF, action 201, supporting a requested TURN & STUN capability and triggers, action 202, Session Establishment procedure towards the selected UPF including the following parameters: App-ID and Requested TURN and/or STUN configuration.

FIG. 2c shows a flowchart describing a method performed by a second network node 600, such as the NRF, the NEF, the PCF, or the UPF, for handling communication related to a UE in a communications network. Optional actions are marked with dashed boxes.

Action 211. The second network node 600 receives a message from the first network node 500, wherein the message is related to the proxy capability such as a TURN and/or STUN capability. The second network node 600 may be a core network node such as a network function node, and the message may be a request with an indication of a proxy configuration such as a TURN and/or STUN configuration for a communication such as a direct communication, an end-end communication or similar.

Action 212. The second network node 600 may store indication of the proxy capability and/or proxy configuration.

Action 213. The second network node 600 may authorize the received request and/or registration.

Action 214. The second network node 600 may transmit confirmation indicating successful operation, such as accepting the registration.

Action 215. The second network node 600 may generate a PCC rule based on a subscriber policy data that includes a policy for allocating TURN and/or STUN server with specific configuration for the App-ID.

Action 216. The second network node 600 may apply configuration or actions related to the STUN or TURN configuration.

Action 217. The second network node 600 may send traffic according to requested TURN and/or STUN configuration.

The second network node 600 may be an NRF that receives a registration message from a UPF, action 211, wherein the registration message comprises a proxy capability such as a TURN and/or STUN capability. The NRF stores, action 212, an indication of proxy capability and may answer, action 214, UPF with a confirmation message indicating successful operation.

The second network node 600 may be an NEF that receives, action 211, a request to deploy/assign/select TURN and/or STUN server/s inside a communications network of the MNO. The request comprises a Requested Proxy configuration: identifies the requested Proxy configuration, e.g. to indicate allocation of a TURN server and/or a STUN server and the corresponding configuration. The NEF authorizes, action 213, the request, and answers, action 214, an AS with a confirmation message indicating successful operation and stores it in UDR, action 212.

The second network node 600 may be a policy node such as a PCF that retrieves, action 211, from the UDR, a subscriber policy data that includes a policy for allocating TURN and/or STUN server with specific configuration for the App-ID. The policy node generates, action 215, one or more PCC rules including a PCC rule for the App-ID including the requested TURN & STUN configuration.

The second network node 600 may be a UPF that detects, action 211, traffic for an App-ID and applies, action 216, actions requested in a forwarding action rule (FAR) comprising requested TURN and/or STUN configuration. The UPF further sends, action 217, traffic according to requested TURN and/or STUN configuration.

The second network node 600 may be a TURN and/or STUN node that receives traffic, action 211, and applies requested TURN and/or STUN configuration, action 216.

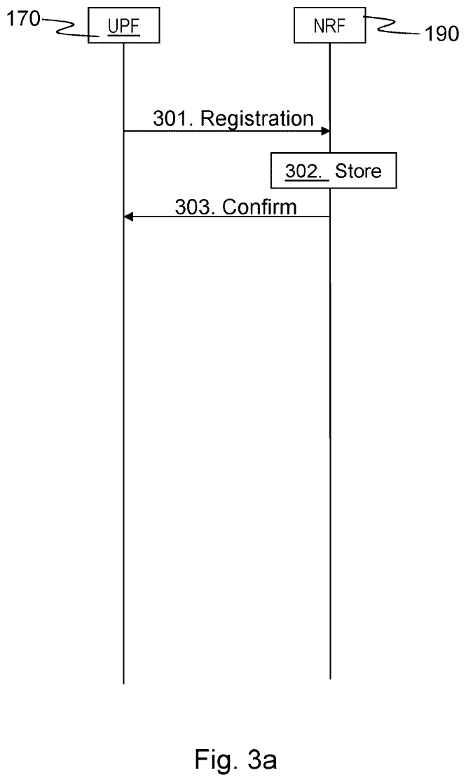

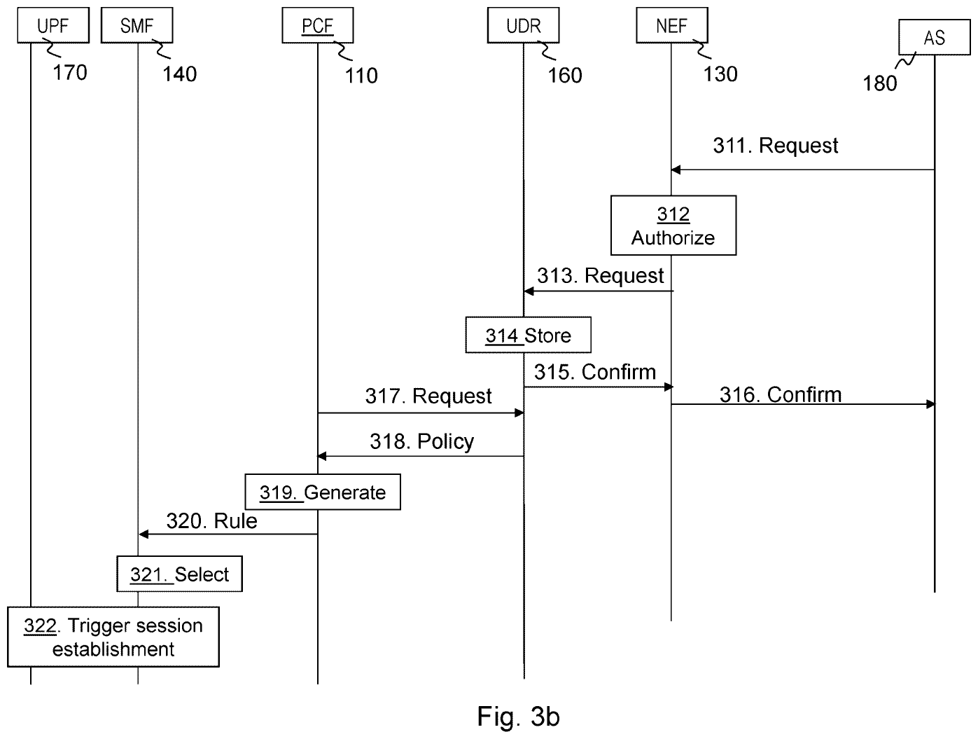

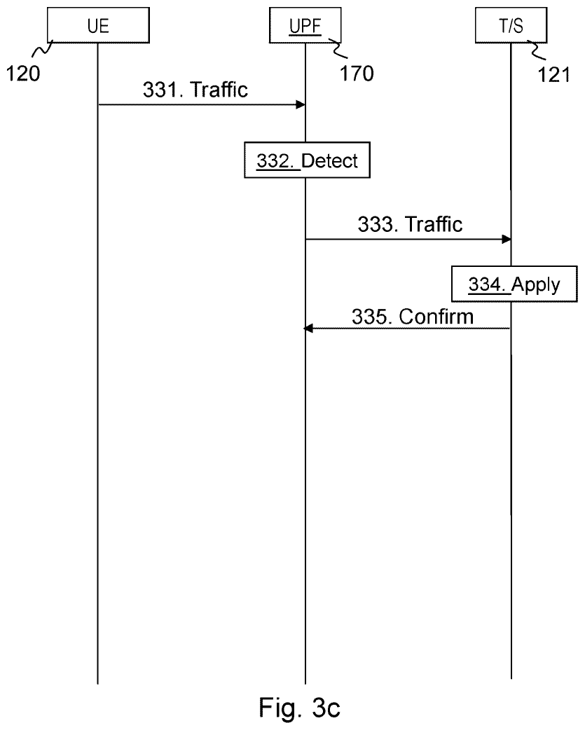

FIG. 3a is a combined signalling scheme and flowchart according to some embodiments herein.

Action 301. The UPF 170 registers, e.g., in NRF 190, the support for TURN and/or STUN capability by triggering a Nnrf_Registration Request message including the following information:
UPF-ID
Location
TURN and STUN capability. This indicates the UPF instance supports this capability. It is assumed a UPF 170 with built-in TURN and STUN logic, e.g., as an embedded service function (SF), but it might be possible that the TURN and STUN logic is external to the UPF 170, e.g., co-located.
   This allows to select or reselect a UPF instance supporting the new capability.

Action 302. The NRF 190 stores, as part of an extension of the UPF profile, the information and capability received

Action 303. The NRF 190 sends indication indicating successful operation.

FIG. 3b is a combined signalling scheme and flowchart according to some embodiments herein.

Action 311. The AS 180 may send a request towards the NEF 130 to deploy/assign/select TURN and/or STUN server/s inside the MNO's network, e.g., edge and/or UPF. It is proposed to create a new Nnef API, e.g., Nnef_TURN&STUN, including the following parameters:
AF-ID: Identifies the Content Provider, e.g., Microsoft.
App-ID, e.g. MS Teams: identifies the application for which the request applies.
(optional) list of UE-ID (A and B): identifies the users/subscribers for which the request applies.
Requested Proxy configuration: identifies the requested Proxy configuration, e.g. to indicate allocation of a TURN server and/or a STUN server and the corresponding configuration.

Action 312. The NEF 130 may authorize the request.

Action 313. The NEF 130 may furter answer the AS indicating successful operation.

Action 314. The NEF 130 may store it in UDR 160, by triggering a Nudr_Store Request message including the following parameters (copied from action 311 above):
AF-ID: Identifies the Content Provider, e.g., Microsoft.
App-ID, e.g., example. com: identifies the application for which the request applies.
(optional) list of UE-ID (A and B): identifies the users/subscribers for which the request applies.
Requested Proxy configuration: identifies the requested Proxy configuration, e.g., to indicate allocation of a TURN server and/or a STUN server and the corresponding configuration.

Action 315. The UDR 160 may answer the message indicating successful operation.

Action 316. The NEF 130 may answer the message in action 316 indicating successful operation.

Action 317. The PCF 110 may transmit a request to the UDR 160 for the subscriber policy data, which may be a policy for allocating TURN and/or STUN server with specific configuration for the App-ID.

Action 318. The UDR 160 may then transmit the subscriber policy data to the PCF 110.

Action 319. The PCF 110 may further generate one or more PCC rules including a PCC rule for App-ID, including the requested TURN & STUN configuration, as follows: PCC rule including:
App-ID
Requested TURN and/or STUN configuration

Action 320. The PCF110 may transmit the PCC rule to the SMF 140.

Action 321. The SMF 140 may select a UPF supporting the requested TURN & STUN capability.

Action 322. The SMF 140 may trigger PFCP Session Establishment procedure towards the UPF 170 including the following parameters:
packet detection rule (PDR) with packet detection information (PDI) set to App-ID
FAR including Requested TURN and/or STUN configuration

FIG. 3c is a combined signalling scheme and flowchart according to some embodiments herein.

Action 331. The UE 120 generates traffic for application

Action 332. The UPF 170 may detect traffic for the App-ID.

Action 333. The UPF 170 may then forward the traffic to a TURN &/or STUN entity 121, e.g., acting as external SF, through service chaining and passing as metadata, e.g., NSH, the requested TURN and/or STUN configuration.

Action 334. The TURN & STUN (T/S) 121 applies the requested configuration.

Action 335. The TURN & STUN 121 may confirm to the UPF.

An example of a proposed mechanism may be as follows:
UPF registers a capability, e.g., TURN&STUN server support. This can be done either through NRF or through PFCP Association procedure with SMF.
Content provider, that is the AF/AS, triggers a request towards MNO to deploy/assign/select TURN and/or STUN server/s inside the MNO's network, e.g., edge and/or UPF, with a specific configuration. It is proposed to create a new Nnef API, e.g., Nnef_TURN&STUN, including the following parameters:
   AF-ID: Identifies the Content Provider, e.g., Microsoft.
   App-ID, e.g., MS Teams: identifies the application for which the request applies.
   (Optional) list of UE-ID (A and B): identifies the users/subscribers for which the request applies.
   Requested Proxy configuration: identifies the requested Proxy configuration, e.g., to indicate allocation of a TURN server and/or a STUN server and the corresponding configuration.
NEF authorizes and stores the request in UDR in a new data structure.
For each protocol data unit (PDU) session (UE #A and UE #B), PCF retrieves the above information stored in UDR and generates a (new) extended PCC rule towards SMF which includes the requested proxy, e.g., TURN server and/or a STUN server, configuration.
SMF translates the PCC rule into PDR/FAR/QER/URR, specifically a (new) extended FAR towards UPF which includes the requested proxy configuration.
UPF applies the requested proxy configuration. It is assumed a UPF with built-in proxy logic, e.g., as an embedded SF, but it might be possible that the proxy logic is external to UPF, e.g., co-located.
   In summary, it is proposed an MNO proxy enabler for WebRTC:
Located inside the UPF as a new, embedded, SF.
Located as a new node.

It is proposed interaction with DNS, so each sub-proxy, e.g., the different configurations of the proxy or the proxies with extended features, can be reachable by end users.

Each Content Provider might place its TURN & STUN proxy inside the generic MNO's Proxy, e.g., for specific implementations, or use the API provided by the MNO's proxy.
Proprietary solution, e.g., the proxy must support to allocate sub-proxies.
Generic API: the proxy provides an API for Content Providers

### EXAMPLES

One may have a proprietary implementation of TURN, e.g., extensions of the standard. They may be interested in allocating the proprietary solution in the WebRTC SF.
WhatsApp don't have a proprietary solution. They just want STUN/TURN to provide VoIP services. They can use the generic solution as an API.

Interactions between Content Provider's outside logic and proxy through the NEF.

Embodiments mentioned above will now be further described and exemplified. The embodiments below are applicable to and may be combined with any suitable embodiment described above.

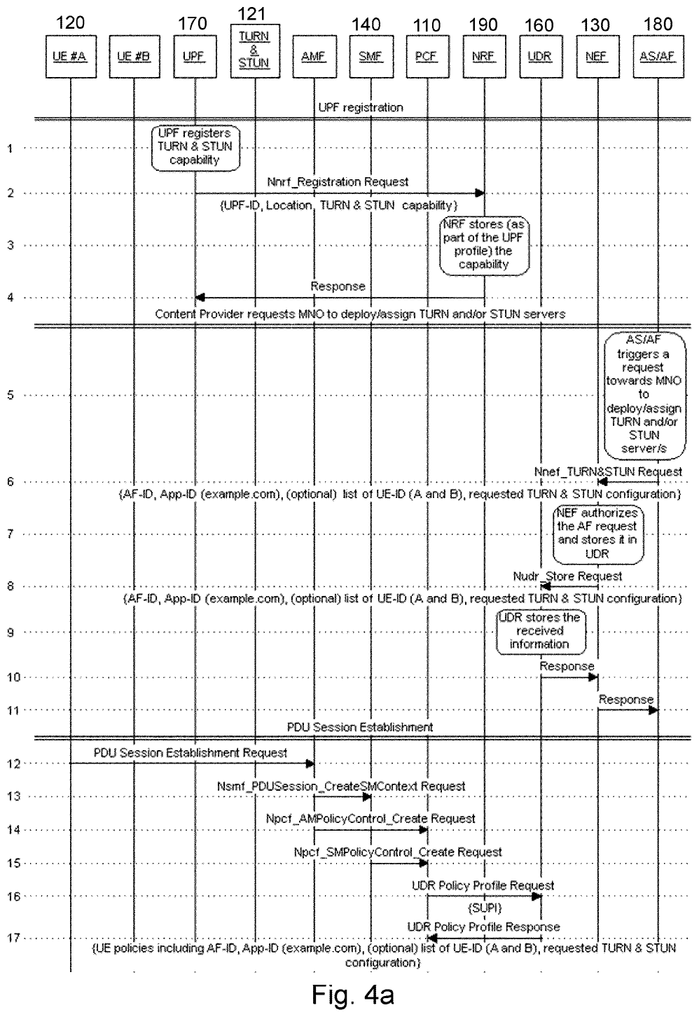

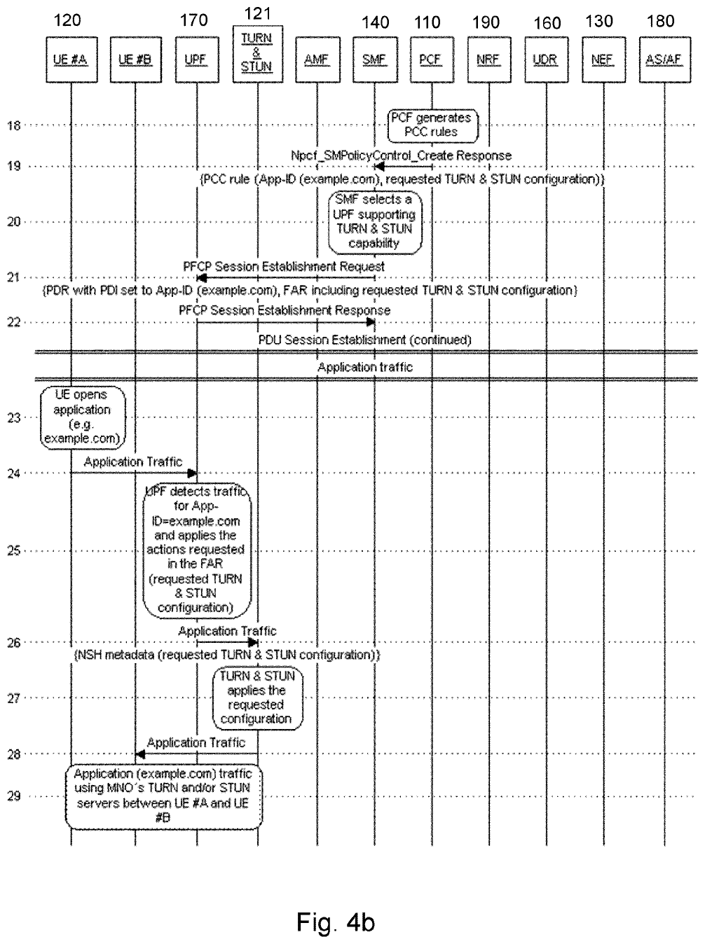

FIGS. 4a-4b shows a sequence diagram describing the proposed mechanism. Steps are detailed below:

Steps 1 and 2) UPF 170 registers, e.g., in NRF 190, the support for TURN and STUN capability by triggering a Nnrf_Registration Request message including the following information:
UPF-ID
Location
(New) TURN and STUN capability. This indicates the UPF instance supports this capability. It is assumed a UPF with built-in TURN and STUN logic, e.g., as an embedded SF, but it might be possible that the TURN and STUN logic is external to UPF, e.g., co-located.
   This allows to select/-reselect a UPF instance supporting the new capability.
   Steps 3 and 4) NRF 190 stores, e.g., as part of an extension of the UPF profile, the information and capability received in Step 2 and answers UPF 170 indicating successful operation.
   Steps 5 and 6) AF/AS 180 triggers a request towards MNO to deploy/assign/select TURN and/or STUN server/s inside the MNO's network, e.g., edge and/or UPF. It is proposed to create a new Nnef API (Nnef_TURN&STUN) including the following parameters:
AF-ID: Identifies the Content Provider, e.g., Microsoft.
App-ID, e.g., MS Teams: identifies the application for which the request applies.
(optional) list of UE-ID (A and B): identifies the users/subscribers for which the request applies.
Requested Proxy configuration: identifies the requested Proxy configuration, e.g., to indicate allocation of a TURN server and/or a STUN server and the corresponding configuration.
   The sequence diagram in FIGS. 4a-4b is just an example showing the scenario where the AF 180 triggers the subscription before user opens the app. Note the AF subscription can also be triggered right after the user opens the app.
   Steps 7 to 9) NEF 130 authorizes the AF request, answers AF indicating successful operation and stores it in UDR 160, by triggering a Nudr_Store Request message including the following parameters (copied from Step 6 above):
AF-ID: Identifies the Content Provider, e.g., Microsoft.
App-ID, e.g., example. com: identifies the application for which the request applies.
(optional) list of UE-ID (A and B): identifies the users/subscribers for which the request applies.
Requested Proxy configuration: identifies the requested Proxy configuration, e.g., to indicate allocation of a TURN server and/or a STUN server and the corresponding configuration.
   Step 10) UDR 160 answers the message in Step 8 indicating successful operation.
   Step 11) NEF 130 answers the message in Step 6 indicating successful operation.
   Steps 12 to 15) UE 120 triggers PDU Session Establishment procedure. As part of this procedure, AMF creates the policy association with the PCF 110 (Step 14) and SMF 140 creates the policy association with the PCF 110 (Step 15).
   Steps 16 and 17) PCF 110 retrieves from UDR 160 the subscriber policy data, i.e., the policy data for this user's PDU session, which in this example includes a policy for allocating TURN and/or STUN server 121 with specific configuration for the App-ID (example. com).
   Steps 18 and 19) PCF 110 generates PCC rules including a PCC rule for App-ID (example. com). including the requested TURN & STUN configuration, as follows: PCC rule including:
App-ID, e.g., example.com.
(New) Requested TURN and/or STUN configuration.
   Steps 20 to 22) SMF 140 selects a UPF 170 supporting the requested TURN & STUN capability and triggers PFCP Session Establishment procedure towards UPF 170 including the following parameters:
PDR with PDI set to App-ID, e.g., example.com.
FAR including (new) Requested TURN and/or STUN configuration
   Steps 23 and 24) UE 120 generates traffic for application (e.g. example.com)
   Steps 25 and 26) UPF 170 detects traffic for App-ID=example.com and applies the actions requested in the FAR, e.g., requested TURN and/or STUN configuration. In the example sequence diagram in FIGS. 4a-4b, UPF 170 forwards the traffic to a TURN&STUN entity 121, e.g., acting as external SF, through service chaining and passing as metadata, e.g. NSH, the requested TURN and/or STUN configuration.
   Steps 27 and 28) TURN & STUN entity 121 applies the requested configuration.
   Step 29) Application, e.g., example.com, traffic using MNO's TURN and/or STUN servers between UE #A and UE #B.
   Finally, the solution described herein does not only apply to 5G network architecture, but the same mechanisms can be applied to 4G, just by replacing:
AF by service capability server (SCS)/AS
NEF by service capability exposure function (SCEF)
PCF by policy and charging rules function (PCRF)
SMF by PDN gateway control plane function (PGW-C) or Traffic Detection Function Control plane function (TDF-C)
UPF by PDN Gateway User plane function (PGW-U) or Traffic Detection Function User plane function (TDF-U).

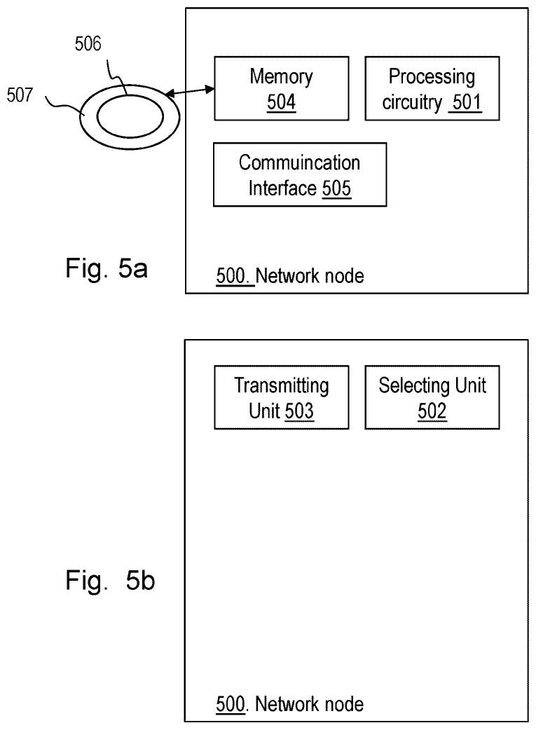

FIGS. 5a-5b are schematic overviews depicting the network node 500, such as a UPF 170, an AS 180, a UDR 160, or an SMF 140, for handling communication related to a UE in a communications network.

The network node 500 may comprise processing circuitry 501, e.g. one or more processors, configured to perform the methods herein.

The network node 500 may comprise a selecting unit 502. The network node 500, the processing circuitry 501 and/or the selecting unit 502 may be configured to select a UPF supporting a requested TURN & STUN capability.

The network node 500 may comprise a transmitting unit 503, such as a transmitter or similar. The network node 500, the processing circuitry 501 and/or the transmitting unit 503 is configured to transmit the message to another network node, wherein the message is related to the proxy capability such as the TURN and/or STUN capability in the communication such as a direct communication, an end-end communication or similar. The network node 500 may be a core network node such as a network function node, and the message may be a request with an indication of a proxy configuration such as a TURN and/or STUN configuration. For example, the network node 500 may be a UPF that is configured to transmit a registration message to an NRF, wherein the registration message comprises a proxy capability such as a TURN and/or STUN capability. Another example, the network node 500 may be an AS that is configured to transmit a request towards MNO, to a NEF, to deploy/assign/select TURN and/or STUN server/s inside a communications network of the MNO. The request comprises a Requested Proxy configuration, which request identifies the requested Proxy configuration, e.g., to indicate allocation of a TURN server and/or a STUN server and the corresponding configuration. The network node 500 may be a UDR that is configured to transmit, to a PCF, a subscriber policy data that includes a policy for allocating TURN and/or STUN server with specific configuration for an App-ID. The network node 500 may be a management node such as an SMF that is configured to select a UPF supporting a requested TURN & STUN capability and triggers Session Establishment procedure towards the selected UPF including the following parameters: App-ID and Requested TURN and/or STUN configuration.

The network node 500 may comprise a memory 504. The memory 504 comprises one or more units to be used to store data on, such as indications, requests, messages, configurations, events and applications to perform the methods disclosed herein when being executed, and similar. Furthermore, the network node 500 may comprise a communication interface 505 such as comprising a transmitter, a receiver, a transceiver and/or one or more antennas. The methods according to the embodiments described herein for the network node 500 are respectively implemented by means of e.g. a computer program product 506 or a computer program, comprising instructions, i.e., software code portions, which, when executed on at least one processor, cause the at least one processor to carry out the actions described herein, as performed by the network node 500. The computer program product 506 may be stored on a computer-readable storage medium 507, e.g. a disc, a universal serial bus (USB) stick or similar. The computer-readable storage medium 507, having stored thereon the computer program product, may comprise the instructions which, when executed on at least one processor, cause the at least one processor to carry out the actions described herein, as performed by the network node 500. In some embodiments, the computer-readable storage medium may be a transitory or a non-transitory computer-readable storage medium.

Thus, embodiments herein may disclose a network node for handling communication in a wireless communications network, wherein the network node comprises processing circuitry and a memory, said memory comprising instructions executable by said processing circuitry whereby said network node is operative to perform any of the methods herein.

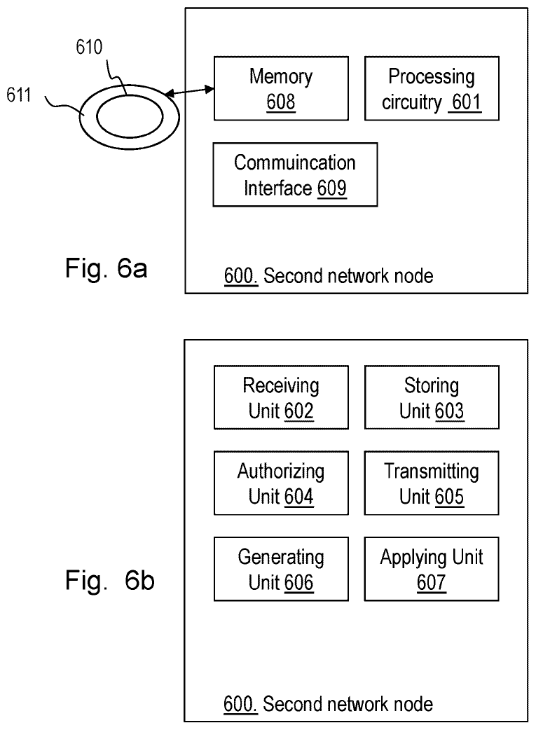

FIGS. 6a-6b are schematic overviews depicting the second network node 600, such as a NRF 190, an AS 180, a UDR 160, a UPF 170, T/S entity 121, or an SMF 140, for handling communication related to a UE in a communications network.

The second network node 600 may comprise processing circuitry 601, e.g. one or more processors, configured to perform the methods herein.

The second network node 600 may comprise a receiving unit 602, such as a receiver or similar. The second network node 600, the processing circuitry 601 and/or the receiving unit 602 is configured to receive the message from the (first) network node, wherein the message is related to a proxy capability such as a TURN and/or STUN capability. The second network node 600 may be a core network node such as a network function node, and the message may be a request with an indication of a proxy configuration such as a TURN and/or STUN configuration for a communication such as a direct communication, an end-end communication or similar.

The second network node 600 may comprise a storing unit 603. The second network node 600, the processing circuitry 601 and/or the storing unit 603 may be configured to store an indication of the proxy capability, such as the STUN and/or TURN capability.

The second network node 600 may comprise an authorizing unit 604. The second network node 600, the processing circuitry 601 and/or the authorizing unit 604 may be configured to authorize the received request and/or registration.

The second network node 600 may comprise a transmitting unit 605, such as a transmitter or similar. The second network node 600, the processing circuitry 601 and/or the transmitting unit 605 may be configured to transmit confirmation indicating successful operation.

The second network node 600 may comprise a generating unit 606. The second network node 600, the processing circuitry 601 and/or the generating unit 606 may be configured to generate a PCC rule based on a subscriber policy data that includes a policy for allocating TURN and/or STUN server with specific configuration for the App-ID.

The second network node 600 may comprise an applying unit 607. The second network node 600, the processing circuitry 601 and/or the applying unit 607 may be configured to apply configuration or actions related to the STUN or TURN configuration.

The second network node 600, the processing circuitry 601 and/or the transmitting unit 605 may be configured to send traffic according to requested TURN and/or STUN configuration.

The second network node 600 may be an NRF that is configured to receive a registration message from a UPF, wherein the registration message comprises a proxy capability such as a TURN and/or STUN capability. The NRF is configured to store an indication of proxy capability and may be configured to answer UPF with a confirmation message indicating successful operation.

The second network node 600 may be an NEF that is configured to receive a request to deploy/assign/select TURN and/or STUN server/s inside a communications network of the MNO. The request comprises a Requested Proxy configuration: identifies the requested Proxy configuration, e.g. to indicate allocation of a TURN server and/or a STUN server and the corresponding configuration. The NEF is configured to authorize the request, and to answer an AS with a confirmation message indicating successful operation and stores it in UDR.

The second network node 600 may be a policy node such as a PCF that is configured to retrieve from the UDR, a subscriber policy data that includes a policy for allocating TURN and/or STUN server with specific configuration for the App-ID. The policy node is configured to generate PCC rules including a PCC rule for the App-ID including the requested TURN & STUN configuration.

The second network node 600 may be a UPF that is configured to detect traffic for an App-ID and to apply actions requested in a forwarding action rule (FAR) comprising requested TURN and/or STUN configuration. The UPF is further configured to send traffic according to requested TURN and/or STUN configuration.

The second network node 600 may be a TURN and/or STUN node that is configured to receive traffic and to apply requested TURN and/or STUN configuration.

The second network node 600 may comprise a memory 608. The memory 608 comprises one or more units to be used to store data on, such as indications, requests, messages, configurations, actions, events and applications to perform the methods disclosed herein when being executed, and similar. Furthermore, the second network node 600 may comprise a communication interface 609 such as input/output interface comprising a transmitter, a receiver, a transceiver and/or one or more antennas. The methods according to the embodiments described herein for the second network node 600 are respectively implemented by means of e.g. a computer program product 610 or a computer program, comprising instructions, i.e., software code portions, which, when executed on at least one processor, cause the at least one processor to carry out the actions described herein, as performed by the second network node 600. The computer program product 610 may be stored on a computer-readable storage medium 611, e.g. a disc, a universal serial bus (USB) stick or similar. The computer-readable storage medium 611, having stored thereon the computer program product, may comprise the instructions which, when executed on at least one processor, cause the at least one processor to carry out the actions described herein, as performed by the second network node 600. In some embodiments, the computer-readable storage medium may be a transitory or a non-transitory computer-readable storage medium.

Thus, embodiments herein may disclose a second network node for handling communication in a wireless communications network, wherein the network node comprises processing circuitry and a memory, said memory comprising instructions executable by said processing circuitry whereby said second network node is operative to perform any of the methods herein.

In some embodiments, a more general term “radio network node” is used, and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments, the non-limiting term wireless device or user equipment (UE) is used, and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles, etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

### Further Extensions and Variations

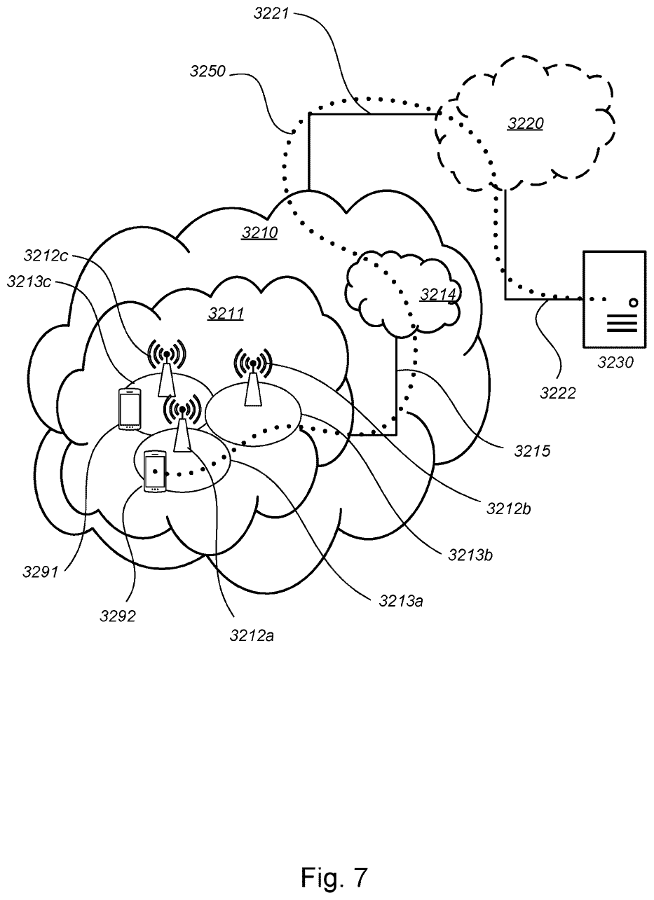

With reference to FIG. 7, in accordance with an embodiment, a communication system includes a telecommunication network 3210, such as a 3GPP-type cellular network, which comprises an access network 3211, such as a radio access network, and a core network 3214. The core network 3214 may e.g. comprise the policy node 110. The access network 3211 comprises a plurality of base stations 3212a, 3212b, 3212c, e.g. the base station 105, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as the radio device 120 and/or a Non-AP STA 3291 located in coverage area 3213c is configured to wirelessly connect to, or be paged by, the corresponding base station 3212c. A second UE 3292 such as the and/or client device 125 and/or a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

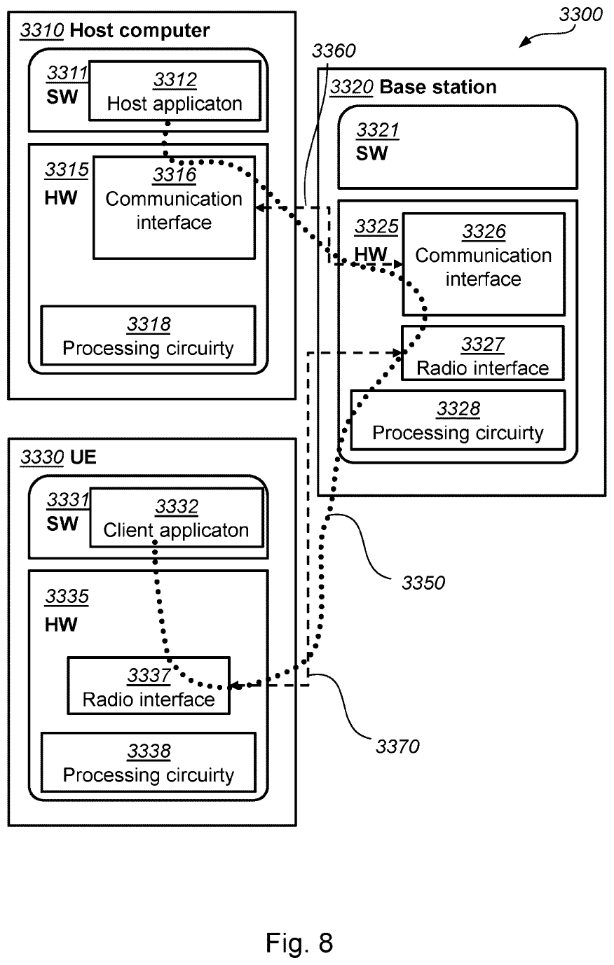

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to setup and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 15) served by the base station 3320. The communication interface 3326 may be configured to facilitate a connection 3360 to the host computer 3310. The connection 3360 may be direct or it may pass through a core network (not shown in FIG. 15) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to setup and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the latency and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

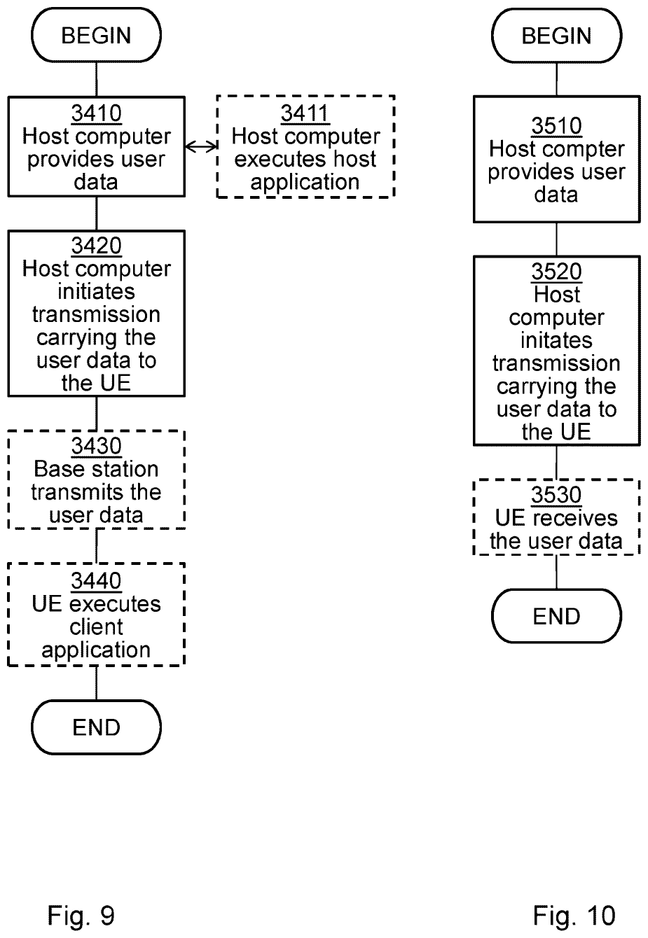

FIG. 9 is a flowchart illustrating a method implemented in a communication system, in accordance with one embodiment. The communication system includes a host computer, a base station such as a AP STA, and a UE such as a Non-AP STA which may be those described with reference to FIG. 7 and FIG. 8. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 10 is a flowchart illustrating a method implemented in a communication system, in accordance with one embodiment. The communication system includes a host computer, a base station such as a AP STA, and a UE such as a Non-AP STA which may be those described with reference to FIG. 7 and FIG. 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

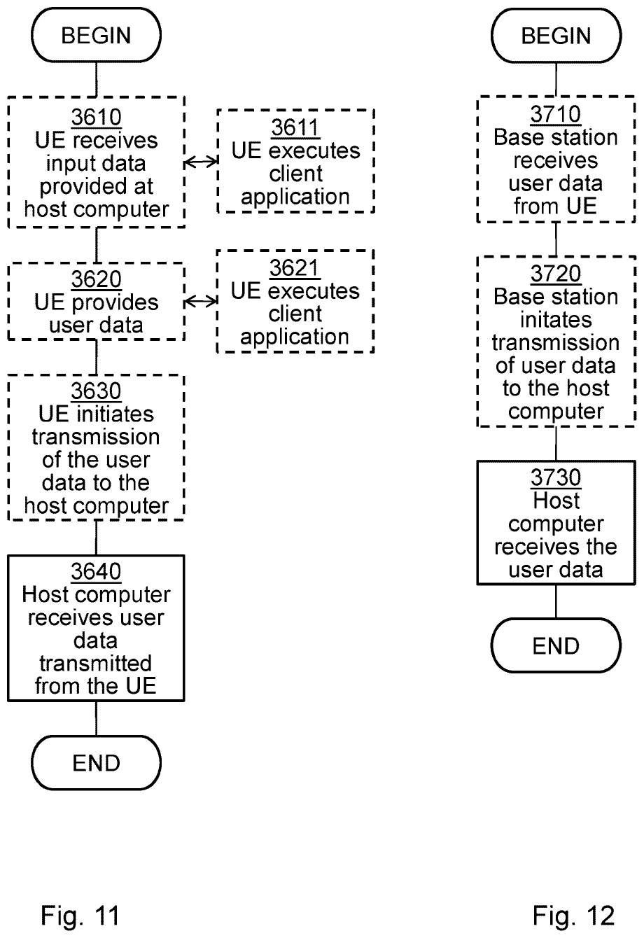

FIG. 11 is a flowchart illustrating a method implemented in a communication system, in accordance with one embodiment. The communication system includes a host computer, a base station such as a AP STA, and a UE such as a Non-AP STA which may be those described with reference to FIG. 7 and FIG. 8. For simplicity of the present disclosure, only drawing references to FIG. 11 will be included in this section. In an optional first step 3610 of the method, the UE receives input data provided by the host computer. Additionally, or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.
AF Application Function
AMF Access and Mobility Function
API Application Programming Interface
AS Application Server
CP Control Plane
CUPS Control User Plane Separation
DL Downlink
DM Data Management
DNN Data Network Name
DPI Deep Packet Inspection
FAR Forwarding Action Rule
FQDN Fully Qualified Domain Name
HTTP Hypertext Transport Protocol
HTTPS Hypertext Transport Protocol Secure
IE Information Element
IMEI International Mobile Equipment Identifier
IMSI International Mobile Subscriber Identifier
IP Internet Protocol
MBB Mobile Broadband
MNO Mobile Network Operator
NAT Network Address Translation
NR Next Generation Radio/New Radio
OAM Operation Administration and Maintenance
P2P Peer to Peer
PCC Policy Charging and Control
PCEF Policy and Charging Enforcement Function
PCF Policy Control Function
PCRF Policy Control Rules Function
PDN Packet Data Network
PDR Packet Detection Rule
PEI Permanent Equipment Identity
PFCP Packet Flow Control Protocol
PFD Packet Flow Description
PGW Packet Gateway
PGW-C PDN Gateway Control plane function
PGW-U PDN Gateway User plane function
PUI Public User Identity
QoE Quality of Experience
QoS Quality of Service
RAN Radio Access Network
SDF Service Data Flow
SF Service Function
SMF Session Management Function
SNI Server Name Indication
S-NSSAI Single-Network Slice Selection Assistance Information
SPR Subscriber Profile Repository
STUN Session Traversal Utilities for Network Address Translation
SUPI Subscription Permanent Identifier
TCO Total Cost of Ownership
TCP Transmission Control Protocol
TLS Transport Layer Security
TURN Traversal Using Relays around NAT
UC Use Case
UDP User Datagram Protocol
UDR Unified Data Repository
UE User Equipment
UL Uplink
UP User Plane
UPF User Plane Function
URR Usage Reporting Rule
VoIP Voice over IP
WebRTC Web Real Time Communications

1. A method performed by a network node for handling communication related to a UE in a communications network, comprising:
transmitting a message to another network node, wherein the message is related to a proxy capability in a communication.

2. The method according to claim 1, wherein the proxy capability comprises at least one of a TURN capability and a STUN capability.

3. The method according to claim 2, further comprising:
selecting a user plane function supporting at least one of a requested TURN capability and a requested STUN capability.

4-5. (canceled)

6. The method according to claim 1, wherein the network node comprises a user plane function that is configured to transmit a registration message to a network repository function, NRF, wherein the registration message comprises a proxy capability.

7. The method according to claim 1, wherein the network node comprises an application function, AS, that is configured to transmit a request towards a mobile network operator, MNO, to a network exposure function, NEF, the request comprising at least one of the following instructions:
deploy at least one of a TURN server and a STUN server inside a communication network of the MNO;
assign at least one of the TURN server and the STUN server inside the communication network of the MNO; and
select at least one of the TURN server and the STUN server inside the communication network of the MNO.

8. The method according to claim 7, wherein the request comprises a requested proxy configuration, which the request identifies the requested proxy configuration to indicate allocation of a corresponding configuration and at least one of a TURN server and a STUN server.

9. The method according to claim 1, wherein the network node comprises a unified data repository, UDR, that is configured to transmit, to a policy control function, PCF, a subscriber policy data that includes a policy for allocating at least one of a TURN server and a STUN server with specific configuration for an application identity, App-ID.

10. The method according to claim 1, wherein the network node comprises a management node that is configured to select a user plane function, UPF, supporting at least one of a requested TURN capability and a requested STUN capability, and the management node triggers a Session Establishment procedure towards the selected UPF including the following parameters: application identity, App-ID, and at least one of a requested TURN configuration and a requested STUN configuration.

11. A method performed by a second network node for handling communication related to a UE in a communications network, comprising:
receiving a message from a first network node, wherein the message is related to a proxy capability in a communication.

12. The method according to claim 11, wherein the proxy capability comprises at least one of a TURN capability and a STUN capability.

13. The method according to claim 12, further comprising receiving a request towards a mobile network operator, MNO, the request comprising at least one of the following instructions:
deploy at least one of a TURN server and a STUN server inside a communication network of the MNO;
assign at least one of the TURN server and the STUN server inside the communication network of the MNO; and
select at least one of the TURN server and the STUN server inside the communication network of the MNO.

14. The method according to claim 12, wherein the request comprises a requested proxy configuration, which the request identifies the requested proxy configuration to indicate allocation of a corresponding configuration and at least one of a TURN server and a STUN server.

15. The method according claim 12, wherein the network node comprises a policy control function, PCF, that is configured to receive a subscriber policy data that includes a policy for allocating at least one of a TURN server and a STUN server with specific configuration for an application identify, App-ID.

16. The method according to claim 12, wherein the network node comprises a user plane function, UPF, supporting at least one of a requested TURN capability and a requested STUN capability, and the method further comprises receiving a Session Establishment procedure towards the UPF including the following parameters: application identify, App-ID, and at least one of a requested TURN configuration and a requested STUN configuration.

17. The method according to claim 12, wherein the second network node comprises a network repository function, NRF, that receives a registration message from a user plane function, UPF, wherein the registration message comprises a proxy capability, the method further comprising:
storing an indication of proxy capability; and
answering the UPF with a confirmation message indicating successful operation.

18. The method according to claim 12, wherein the second network node comprises a network exposure function, NEF, that receives a request comprising at least one of the following instructions:
deploy at least one of a TURN server and a STUN server inside a communication network of a mobile network operator, MNO;
assign at least one of the TURN server and the STUN server inside the communication network of the MNO; and
select at least one of the TURN server and the STUN server inside the communication network of the MNO,
wherein the request comprises a requested proxy configuration, which the request identifies the requested proxy configuration to indicate allocation of a corresponding configuration and at least one of a TURN server and a STUN server; the method further comprising:
authorizing the request;
answering an application function, AS, with a confirmation message indicating successful operation; and
storing the confirmation message in a unified data repository, UDR.

19. The method according to claim 12, wherein the second network node comprises a policy node that retrieves from a unified data repository, UDR, a subscriber policy data that includes a policy for allocating at least one of a TURN server and a STUN server with a specific configuration for an application identity, App-ID, the method further comprising:
generating PCC rules including a policy and charging control, PCC, rule for the App-ID including the specific configuration.

20. The method according to claim 12, wherein the second network node comprises a user plane function, UPF, that:
detects traffic for an application identity, App-ID; and
applies actions requested in a forwarding action rule, the FAR comprising at least one of a requested TURN configuration and a requested STUN configuration,
the method further comprising:
sending traffic according to at least one of the requested TURN configuration and the requested STUN configuration.

21. The method according to claim 11, wherein the second network node comprises at least one of a TURN node and STUN node that receives traffic and applies at least one of a requested TURN configuration and a requested STUN configuration.

22. (canceled)

23. A computer-readable storage medium, having stored thereon a computer program product comprising instructions which, when executed on at least one processor, cause the at least one processor to carry out the method according to claim 3, as performed by the network node.

24-27. (canceled)
